(19) United States
(12) Patent Application Publication
(10) Pub. No.: US 2025/0016603 A1
(43) Pub. Date: Jan. 9, 2025

(54) METHOD FOR TRANSMITTING VEHICLE-TO-X MESSAGES, AND VEHICLE-TO-X COMMUNICATION MODULE

(71) Applicant: Continental Automotive Technologies GmbH, Hannover (DE)

(72) Inventors: Ulrich Stählin, Eschborn (DE); Marc Menzel, Weimar (Lahn) (DE); Sebastian Strunck, Niedernhausen (DE); Bettina Erdem, Kronberg (DE)

(73) Assignee: Continental Automotive Technologies GmbH, Hannover (DE)

(21) Appl. No.: 18/713,355

(22) PCT Filed: Nov. 25, 2022
(86) PCT No.: PCT/DE2022/200277

§ 371 Date: May 24, 2024

(30) Foreign Application Priority Data
Nov. 29, 2021 (DE) 10 2021 213 400.9

(51) Int. Cl. H04W 28/02; G08G 1/09; H04W 28/082

(52) U.S. Cl. CPC H04W 28/0215; G08G 1/091; H04W 28/082

(57) ABSTRACT

Disclosed is a method for transmitting vehicle-to-X messages of a first type and a second type, wherein messages of the second type are transmitted, depending on a ratio of control data to payload data of the respective message, either separately or the payload data thereof are transmitted as part of a message of the first type. Also disclosed is a vehicle-to-X communication module for carrying out such a method.

The invention relates to a method for transmitting vehicle-to-X messages and to an associated vehicle-to-X communication module.

Vehicle-to-X communication is currently undergoing development and standardization and is in the first steps of market launch. The aim is for motor vehicles and infrastructure facilities to exchange information that is relevant to safety and traffic flow management with one another.

It is becoming increasingly relevant to utilize transmitted resources for the transmission of vehicle-to-X messages in a meaningful way.

It is therefore an object of the invention to provide an alternative or improved method, in relation to known embodiments, for transmitting vehicle-to-X messages. Further, an object of the invention is to provide an associated vehicle-to-X communication module. This is achieved according to the invention by means of a method and a vehicle-to-X communication module according to the respective main claims. Advantageous configurations can be found, for example, in the respective dependent claims. The content of the claims is incorporated in the content of the description by express reference.

The invention relates to a method for transmitting vehicle-to-X messages of a first type and a second type. Each message is composed of payload data and control data. The messages of the first type are transmitted at least within a period of time at a transmission rate. Payload data of the messages of the second type are transmitted, depending on their respective ratio of control data to payload data, either in messages of the second type which are separate to the messages of the first type, or are extracted from the respective message of the second type and transmitted as part of a respective message of the first type.

Such a method can be used to reduce overall the channel load and achieve better utilization of existing resources for transmitting vehicle-to-X messages.

As mentioned, the messages are basically composed of respective payload data and control data. Payload data are those that provide the recipient with potentially relevant information, that is to say a location of a motor vehicle or an indication of a hazardous situation, for example. Many other items of information can also be transferred accordingly. Control data are those data that do not contain such information, but instead contribute to the functionality of the vehicle-to-X communication. For example, metadata or items of information relating to the security of the data communication are transferred therein.

The messages of the first type are typically those that are typically transmitted anyway. These messages are, for example, basic safety messages or cooperative awareness messages, which, for example, continuously provide information about basic data such as location, route or speed of a motor vehicle. The ratio of control data to payload data of said messages is typically constant or at least roughly constant, that is to say constant within a bandwidth, for example.

On the other hand, messages of the second type are typically subject to significantly higher fluctuations in terms of the ratio of control data to payload data of said messages. It is therefore possible that a very large amount of payload data are transmitted with a single message of the second type, which typically justifies the transmission thereof as a separate message. However, if the ratio of control data to payload data is poor as only very little payload data are allotted to the control data necessary for this, it makes sense not to transmit said payload data separately in a message of the second type, but instead to pack them into a message of the first type that has to be transmitted anyway. Overall, this improves the ratio of control data to payload data, as more payload data can be transferred overall with the same amount of control data.

A message of the first type is typically present in a data processing device as such, that is to say as a compilation of payload data and control data, which are then transmitted. A message of the second type may also be present as such, before a decision is made as to whether it is transmitted separately, or it may also be present in such a way that only the payload data are available and the ratio of control data to payload data is determined on the basis of this. If it is to be subsequently decided that the message is not transmitted separately, the payload data can be inserted into a message of the first type that is to be transmitted anyway. Otherwise, the control data can be added and the message can be transmitted as a message of the second type.

The payload data of the messages of the second type can be transmitted, in particular, in separate messages of the second type if the ratio is at most as high as a threshold value. The setting of this threshold value allows a clear separation between the two procedures.

The payload data of the messages of the second type may in particular be essentially transmitted as part of a respective message of the first type if the ratio is greater than the threshold value. In this case, transmitting a message of the second type separately would not be worthwhile.

In particular, the more payload data of the messages of the second type are transmitted as part of a respective message of the first type, the greater the ratio. This allows flexible adaptation, for example by means of a predefined function. This can be done either inherently or else above the threshold value mentioned above.

In particular, a message of the first type, which contains payload data of the message of the second type, can have less control data than the sum of the control data of the message of the first type and the message of the second type. This allows overall a saving of control data and thus relief of the load on the communication.

In particular, a message of the first type, which contains payload data of a message of the second type, can have just as much control data as a message of the first type without the payload data of the message of the second type. This means that additional control data can be completely dispensed with, which allows maximum relief of the load on the data transmission.

The payload data of a message of the second type can be transmitted in particular in a container of a message of the first type. Such a container can be provided to store the payload data of the message of the second type. Said container can be identified as such by a recipient and so the recipient immediately knows that the message contains payload data of a message of the second type.

According to a preferred embodiment, a channel load is also determined. This allows additional control functionalities, for example those that are described in more detail further below.

The payload data of the messages of the second type can also be transmitted, depending on the channel load, either in messages of the second type which are separate to the messages of the first type, or transmitted as part of a respective message of the first type. As a result, the channel load can be taken into account in the type of transmission of payload data of messages of the second type, so that, for example, it is possible to react to a high channel load by transmitting more payload data of messages of the second type as components of messages of the first type.

A first channel load of a first channel can be determined and a second channel load of a second channel can be determined. In particular, the messages can be distributed to the first channel and the second channel in particular depending on the channel loads. In particular, provision can therefore be made for more messages to be transmitted on a channel with a lower channel load, which results overall in a better utilization of the available channel capacities.

The messages of the second type, or the payload data thereof, can contain in particular information relating to one or more of the following categories:
identified external objects,
maneuver planning.

However, other data may also be included.

The transmission rate can specify in particular a constant time interval between messages of the first type and/or a transmission pattern for messages of the first type within the period of time. With a constant time interval, a message of the first type is always transmitted after this time interval has passed, said message either containing only payload data of this message of the first type or also containing payload data of a message of the second type. If a transmission pattern is specified, more complex transmissions can be implemented, wherein intervals between two respectively directly adjacent messages can be fixed, for example with several values, or can depend on other parameters or events.

The messages of the first type can be, for example, cooperative awareness messages, basic safety messages, beacon messages and/or messages about location, speed and/or route of a vehicle. These are typically messages that are transmitted continuously anyway in order to inform the environment about the most important safety-relevant data of the respective motor vehicle.

The messages of the second type can be in particular maneuver coordination messages, cooperative awareness messages, decentralized environment notification messages, event-based messages and/or messages about an object external to the transmitter and/or about an event. Such messages are typically generated depending on events or information that are not as predictable as those of the messages of the first type, with the result that their payload data are subject to a much larger fluctuation range in terms of their length.

The invention further relates to a vehicle-to-X communication module, which is configured to carry out a method as described herein. The invention further relates to a non-volatile computer-readable storage medium which contains program code, during the execution of which a processor carries out a method as described herein. In respect of the method, reference can in each case be made here to all of the embodiments and variants described herein.

In other words, for example, maneuver coordination messages (MCM) and cooperative perception messages (CPM) are new types of messages intended to enable cooperative driving. As with any additional message, these messages consist not only of payload data, but also of overhead. In order to keep the channel load as low as possible, the aim is generally to maximize the ratio of payload data to overhead.

This is where the procedure described here starts. If a CPM and/or MCM falls below a certain amount of payload data, instead of a dedicated CPM or MCM for that content, a container containing the corresponding content is attached to a BSM or CAM instead. Since BSM or CAM are typically transmitted anyway, this approach improves the ratio of payload data to overhead. Since the corresponding container is relatively small (otherwise a dedicated message would indeed be transmitted), BSM or CAM remain small enough for a robust transmission too. In an infrastructure system, a corresponding container can also be integrated into messages such as SPaT or MAP.

The following topology could also be used: The MCM or CPM is attached to the BSM/CAM as an optional container, thereby saving on the ego section that is relevant to both. In this case, an either/or is typically implemented. This means that there is then either a CAM, a CAM+MCM, or a CAM+CPM. However, the CAM+CPM can become quite large and then, for example, the maximum number of objects is reduced from 30 to 20 with 1,400 bytes. On the infrastructure side, for example, a CAM/BSM with CPM can be permitted or a roadside unit can be provided as the transmitter type.

If CAM/BSM and CPM and MCM are transmitted on different channels, the channel load of the different channels can be included in the decision, for example. The channel with lower utilization is then preferred.

Further features and advantages will be taken by a person skilled in the art from the exemplary embodiment described below with reference to the appended drawing. In the drawing:

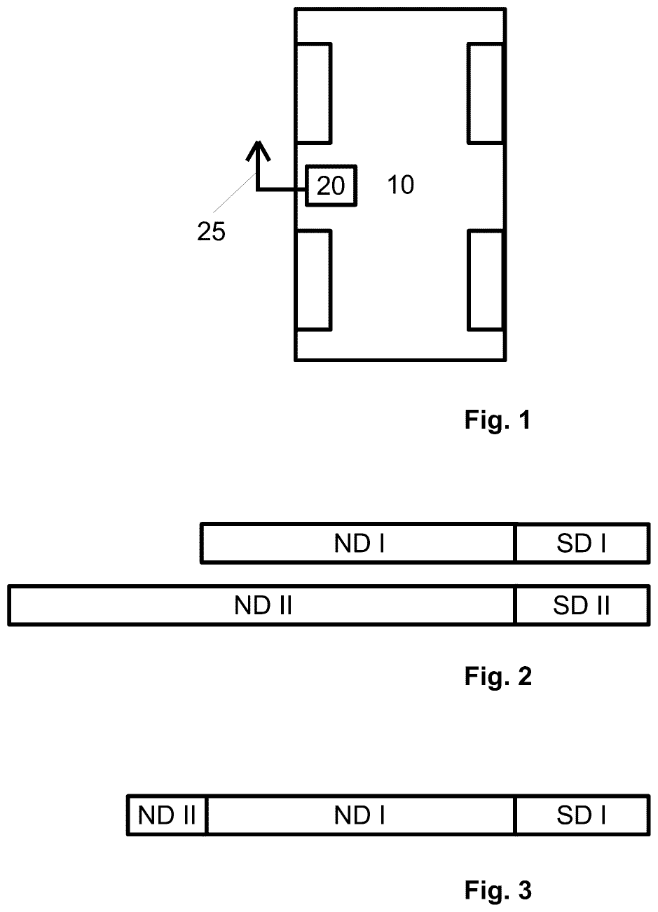

FIG. 1: shows a motor vehicle,

FIG. 2: shows two messages, and

FIG. 3: shows one message.

FIG. 1 purely schematically shows a motor vehicle 10 having a vehicle-to-X communication module 20, to which an antenna 25 is attached. This allows the motor vehicle 10 to participate in the vehicle-to-X communication. The motor vehicle 10 continuously detects both its own state and its surroundings by means of sensors, which are not shown in more detail. Corresponding information derived from this can be transmitted via the vehicle-to-X communication to inform other road users and infrastructure facilities about this.

A possible type of transmission is shown in FIG. 2, which shows two messages. The top message is of a first type and the bottom message is of a second type. This is illustrated in each case by Roman numerals I and II, respectively.

In the message of the first type, control data SD and payload data ND are combined. In the message of the second type, control data SD and payload data ND are also combined. The payload data ND are in each case significantly more extensive than the respective control data SD, so that in both cases it is worthwhile to transmit the respective message separately.

FIG. 3 shows another state. The amount of payload data ND of a message of the second type is much smaller than control data SD that would be required for transmitting said payload data ND. They are therefore not transmitted separately in a message of the second type, but are attached to a message of the first type. This saves control data overall and thus contributes to reducing the load on existing data transmission resources.

In general, it should be pointed out that vehicle-to-X communication is understood to mean in particular a direct communication between vehicles and/or between vehicles and infrastructure devices. By way of example, it may thus be vehicle-to-vehicle communication or vehicle-to-infrastructure communication. Where this application refers to a communication between vehicles, said communication can fundamentally take place as part of a vehicle-to-vehicle communication, for example, which is typically effected without switching by a mobile radio network or a similar external infrastructure and which must therefore be distinguished from other solutions based on a mobile radio network, for example. By way of example, a vehicle-to-X communication can be effected using the IEEE 802.11p or IEEE 1609.4 standard. Other examples of communication technologies include LTE-V2X, 5G-V2X, C-V2X, WLAN, WiMax, UWB or Bluetooth. A vehicle-to-X communication can also be referred to as C2X communication. The subareas can be referred to as C2C (car-to-car) or C2I (car-to-infrastructure). However, the invention explicitly does not exclude vehicle-to-X communication with switching via a mobile radio network, for example.

Mentioned steps of the method according to the invention can be executed in the order indicated. However, they can also be executed in a different order, if technically feasible. In one of its embodiments, for example with a specific combination of steps, the method according to the invention may be carried out in such a way that no further steps are carried out. In principle, however, further steps, even steps which have not been mentioned, may also be carried out.

It is pointed out that features may be described in combination in the claims and in the description, for example in order to facilitate understanding, even though these can also be used separately from one another. A person skilled in the art will recognize that such features may also, independently of one another, be combined with other features or combinations of features.

Dependency references in dependent claims may characterize preferred combinations of the respective features but do not exclude other combinations of features.

### LIST OF REFERENCE DESIGNATIONS

10 Motor vehicle
20 Vehicle-to-X communication module
25 Antenna
ND Payload data
SD Control data

1. A method for transmitting vehicle-to-X messages of a first type and a second type,
wherein each message comprises payload data and control data,
wherein the messages of the first type are transmitted at least within a period of time at a transmission rate,
wherein payload data of the messages of the second type are transmitted, depending on their respective ratio of control data to payload data,
either in messages of the second type which are separate to the messages of the first type, or
are extracted from the respective message of the second type and transmitted as part of a respective message of the first type.

2. The method as claimed in claim 1,
wherein the payload data of the messages of the second type are transmitted in separate messages of the second type if the ratio is at most as high as a threshold value.

3. The method as claimed in claim 2,
wherein payload data of the messages of the second type are transmitted as part of a respective message of the first type if the ratio is greater than the threshold value.

4. The method as claimed in claim 1,
wherein the more payload data of the messages of the second type are transmitted as part of a respective message of the first type, the greater the ratio.

5. The method as claimed in claim 1,
wherein a message of the first type, which contains payload data of a message of the second type, has less control data than a sum of the control data of the message of the first type and the message of the second type.

6. The method as claimed in claim 1,
wherein a message of the first type, which contains payload data of a message of the second type, has just as much control data as a message of the first type without the payload data of the message of the second type.

7. The method as claimed in claim 1,
wherein the payload data of a message of the second type are transmitted in a container of a message of the first type.

8. The method as claimed in claim 1,
wherein a channel load is also determined.

9. The method as claimed in claim 8,
wherein the payload data of the messages of the second type are also transmitted, depending on the channel load, either in messages of the second type which are separate to the messages of the first type, or transmitted as part of a respective message of the first type.

10. The method as claimed in claim 1,
wherein a first channel load of a first channel is determined and a second channel load of a second channel is determined, and
wherein the messages are distributed to the first channel and the second channel depending on the channel loads.

11. The method as claimed in claim 1,
wherein the messages of the second type, or the payload data thereof, contain information relating to one or more of the following categories:
identified external objects,
maneuver planning.

12. The method as claimed in claim 1,
wherein the transmission rate specifies a constant time interval between messages of the first type and/or a transmission pattern for messages of the first type within the period of time.

13. The method as claimed in claim 1,
wherein the messages of the first type are cooperative awareness messages, basic safety messages, beacon messages and/or messages about location, speed and/or route of a vehicle.

14. The method as claimed in claim 1,
wherein the messages of the second type are maneuver coordination messages, cooperative awareness messages, decentralized environment notification messages, event-based messages and/or messages about an object external to the transmitter and/or about an event.

15. A vehicle-to-X communication module, which is configured to execute a method as claimed in claim 1.

16. The module as claimed in claim 15,
wherein the payload data of the messages of the second type are transmitted in separate messages of the second type if the ratio is at most as high as a threshold value.

17. The module as claimed in claim 16,
wherein payload data of the messages of the second type are transmitted as part of a respective message of the first type if the ratio is greater than the threshold value.

18. The module as claimed in claim 15,
wherein the more payload data of the messages of the second type are transmitted as part of a respective message of the first type, the greater the ratio.

19. The module as claimed in claim 15,
wherein a message of the first type, which contains payload data of a message of the second type, has less control data than a sum of the control data of the message of the first type and the message of the second type.

20. The module as claimed in claim 15,
wherein a message of the first type, which contains payload data of a message of the second type, has just as much control data as a message of the first type without the payload data of the message of the second type.
